(19) United States
(12) Patent Application Publication
(10) Pub. No.: US 2015/0056444 A1
(43) Pub. Date: Feb. 26, 2015

(54) Adhesive Manufacturing Process, an Adhesive, and an Article

(71) Applicant: Tyco Electronics Corporation, Berwyn, PA (US)

(72) Inventors: Lei Wang, San Jose, CA (US); Hyo Chang Yun, Saratoga, CA (US)

(73) Assignee: Tyco Electronics Corporation, Berwyn, PA (US)

(21) Appl. No.: 14/010,409

(22) Filed: Aug. 26, 2013

(51) Int. Cl. C09J 127/20

(52) U.S. Cl. CPC C09J 127/20
USPC 428/355 EN; 427/208.2; 524/520; 524/546

(57) ABSTRACT

An adhesive manufacturing process, an adhesive, and an article are disclosed. The adhesive manufacturing process includes blending a lower-melt fluoropolymer having a melting point that is less than a first temperature with a fluoropolymer powder having a melting point that is greater than a second temperature to form an adhesive and applying the adhesive to a surface at the first temperature. The adhesive is configured to be exposed to the second temperature. The adhesive includes the lower-melt fluoropolymer and the fluoropolymer powder blended with the lower-melt fluoropolymer. The article includes a surface and the adhesive applied to the surface at an applying temperature.

### FIELD OF THE INVENTION

The present invention is directed to adhesive manufacturing processes, adhesives, and articles having adhesives. More particularly, the present invention is directed to adhesives having a fluoropolymer and a fluoropolymer powder.

### BACKGROUND OF THE INVENTION

Adhesives are used in a variety of environments for a variety of applications. Such environments and applications require adhesives to have specific temperature profiles, viscosity profiles, chemical and flammable resistant profiles, and adhesion characteristics. Known adhesives do not adequately meet all of these requirements.

In wiring applications, adhesives can be used with fluoropolymers. Fluoropolymers have low surface energy, for example, below 25 dynes/cm. This low surface energy makes it difficult for an adhesive to bond to the fluoropolymer. Surface treatments can ameliorate this; however, surface treatments present other problems and are often not available in repair conditions. For example, chemical etching or high energy plasma treatment can be used to activate a fluoropolymer surface. However, etching chemicals (such as sodium naphthalene) cannot be used in a repair area due to the toxicity and flammability. Also, plasma equipment is not able to be used due to the crowded nature of a repair area.

Polytetrafluoroethylene (PTFE) surfaces can be especially difficult for adhesion. Certain polymeric materials are unable to diffuse into the surface, thereby resulting in a lack of adhesion. Polymeric materials that are able to diffuse into the surface may not have desired properties. For example, such materials may drip and/or have melting points being below a maximum service temperature.

Current adhesives do not desirably bond to PTFE. Positioning current adhesives in contact with a surface having PTFE creates a microgap and/or delamination between the adhesive and the PTFE surface.

Certain polymers can provide adhesion to fluoropolymers by having similar chemical structures, relatively low surface energies, and low melting points. Such polymers can have desirable flow and wet-ability on the fluoropolymers. However, such low melting temperatures result in dripping issues in high service temperature applications, such as aerospace applications. The dripping issues can cause seal failure.

Use of certain materials for adhesives has been limited by operational and/or manufacturing conditions. For example, operational and/or manufacturing conditions can require that the adhesive be capable of use over a wide range of temperatures, for example, up to about 300° C. Many materials melt and/or volatilize under such conditions. In addition, some materials generate toxic and/or corrosive emissions. Such materials have limited applicability and/or require additional precautions for use, general safety concerns, and/or equipment damage.

An adhesive manufacturing process, an adhesive, and an article having an adhesive that do not suffer from one or more of the above drawbacks would be desirable in the art.

### BRIEF DESCRIPTION OF THE INVENTION

In an exemplary embodiment, an adhesive manufacturing process includes blending a lower-melt fluoropolymer having a melting point that is less than a first temperature with a fluoropolymer powder having a melting point that is greater than a second temperature to form an adhesive and applying the adhesive to a surface at the first temperature. The adhesive is configured to be exposed to the second temperature.

In another exemplary embodiment, an adhesive includes a lower-melt fluoropolymer having a melting point that is less than a first temperature and one or both of a conductive powder and a fluoropolymer powder blended with the lower-melt fluoropolymer, the fluoropolymer powder having a melting point that is greater than a second temperature. The adhesive is configured to be exposed to the second temperature.

In another exemplary embodiment, an article includes a surface and an adhesive applied to the surface at an applying temperature, the adhesive comprising a lower-melt fluoropolymer having a melting point that is less than the applying temperature and a fluoropolymer powder blended with the lower-melt fluoropolymer, the fluoropolymer powder having a melting point that is greater than an operational temperature. The adhesive is configured to be exposed to the operational temperature.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a schematic view of an article having an adhesive on a surface, according to an embodiment of the disclosure.

### DETAILED DESCRIPTION OF THE INVENTION

Provided are an exemplary adhesive manufacturing process, an adhesive, and an article having an adhesive. Embodiments of the present disclosure, for example, in comparison to articles and adhesives that do not include one or more of the features disclosed herein, are capable of use in specific temperature profiles, are capable of having predetermined viscosity profiles, have high adhesion characteristics (for example, with low surface energy surfaces), increased chemical resistance (for example, with low surface energy surfaces), increased dripping resistance (for example, with low surface energy surfaces), reduced or eliminated flammability, increased service temperature, permit manufacturing of an adhesive at lower temperatures (for example, at or less than about 160° C.), reduce or eliminate toxic and/or corrosive emissions generated by adhesive constituents during manufacturing and/or operation, permit adhesive to be used in aerospace applications, or a combination thereof.

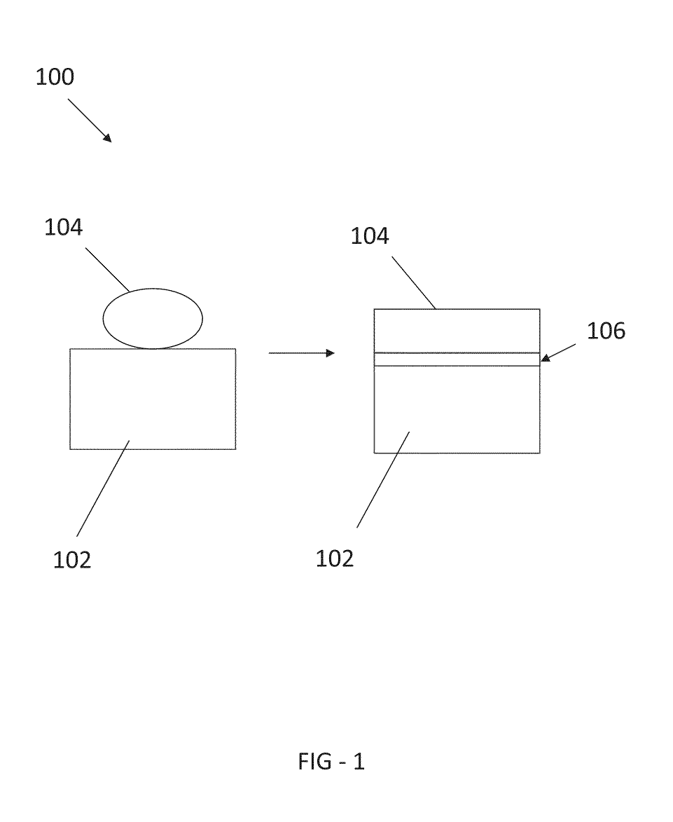

Referring to FIG. 1, in one embodiment, an article 100 includes a surface 102 and an adhesive 104. The adhesive 104 penetrates into a diffusion region 106 of the surface 102. The article 100 includes any suitable material permitting the adhesive 104 to be secured to the article 100. Suitable materials include, but are not limited to, aluminum, ethylene tetrafluoroethylene (ETFE) wire, a fluoropolymer, tape, heat-recoverable tubing (for example, 200° C. heat-recoverable tubing), mold parts, metal surfaces, wire, cable, tubing, and combinations thereof.

The adhesive 104 is applied to the surface 102 at any suitable temperature for any suitable duration. Suitable temperatures include, but are not limited to, about 140° C., about 150° C., about 160° C., between about 140° C. and about 160° C., between about 100° C. and about 200° C., or any suitable combination, sub-combination, range, or sub-range therein. Suitable durations include, but are not limited to, between about 1 minute and about 20 minutes.

The adhesive 104 includes properties corresponding to the desired application, for example, having resistance to fluids (including or not including ketones), being wettable on perfluoropolymer substrates, other suitable properties, or a combination thereof.

The adhesive 104 adheres to the surface 102 in response to a predetermined force, such as through a drum test that is close to a 90-degree peel test, a lab shear test, or a lab peel test that is a 180-degree test.

The adhesive 104 includes a higher-melt component and a lower-melt component. The higher-melt component is a fluoropolymer powder at a concentration, by volume, of less than 100%, for example, between about 1% and about 99%, between about 10% and about 50%, at about 10%, at about 50%, any suitable concentration, or any suitable combination, sub-combination, range, or sub-range therein. The lower-melt component is a lower-melt fluoropolymer at a concentration, by volume, of less than 100%, for example, between about 1% and about 99%, between about 50% and about 90%, at about 50%, at about 90%, any concentration, or any suitable combination, sub-combination, range, or sub-range therein.

The fluoropolymer powder has a melting point that is greater than a maximum service temperature, for example, about 195° C., about 225° C., about 240° C., about 260° C., about 280° C., about 300° C., about 320° C., or any suitable combination, sub-combination, range, or sub-range therein. The lower-melt fluoropolymer has a melting point that is less than the applying temperature, for example, about 100° C., about 115° C., about 130° C., about 170° C., about 200° C., or any suitable combination, sub-combination, range, or sub-range therein. In one embodiment, the melting point of the fluoropolymer powder and/or the melting point of the lower-melt fluoropolymer correspond with a predetermined repair temperature, a predetermined operational temperature, a predetermined cross-link temperature, or a combination thereof. Additionally or alternatively, in one embodiment, the melting point of the lower-melt fluoropolymer is lower than the applying temperature, such as, by at least about 30° C., by between about 10° C. and about 40° C., by between about 10° C. and about 30° C., by between about 20° C. and about 40° C., by between about 20° C. and about 30° C., or any suitable combination, sub-combination, range, or sub-range therein.

The fluoropolymer powder and the lower-melt component are different materials. In one embodiment, the lower-melt component is or includes tetrafluoroethylene-co-hexafluoropropylene-co-vinylidene fluoride terpolymer (hereinafter “THV”), a terpolymer of ethylene, tetrafluoroethylene, and hexafluoropropylene (“EFEP”), polyvinylidene difluoride (“PVDF”), or any suitable thermoplastic fluoropolymer.

In one embodiment, the fluoropolymer powder and/or a conductive powder function(s) as a filler inhibiting melt flow. Suitable fluoropolymer powders and/or conductive powders include, but are not limited to, polytetrafluoroethylene, fluorinated ethylene-propylene (FEP), THV having a higher melting point (for example, 225° C.), copper (such as 5 micrometer dendritic copper), silver flakes, nickel powder, graphene, conductive nickel spheres, EFEP (for example, in embodiments without EFEP as the lower-melt component), other higher-melt fluoropolymers, or combinations thereof. The fluoropolymer powder is a pellet, a micropowder and/or a nanopowder, or a combination thereof, and includes particles within a suitable size range. For example, suitable particle size ranges include, but are not limited to, between about 0.1 micrometers and about 100 micrometers, between about 4 micrometers and about 10 micrometers, between about 10 micrometers and about 50 micrometers, between about 30 micrometers and about 100 micrometers, between about 50 micrometers and about 100 micrometers, between about 0.1 micrometers and about 10 micrometers, about 4 micrometers, about 5 micrometers, or any suitable combination, sub-combination, range, or sub-range therein. In addition to the higher-melt component and the lower-melt component, in some embodiments, the adhesive 104 includes other components and/or the other components form a portion of the higher-melt component and/or the lower-melt component. One suitable other component is a particulate conductive filler, such as carbon black, graphite, metal, metal oxide, conductive coated glass or ceramic beads, particulate conductive polymer, or a combination of these. Such particulate fillers are in the form of powder, beads, flakes, fibers, or any other suitable form. Other suitable components are antioxidants, inert fillers, nonconductive fillers, radiation crosslinking agents (often referred to as prorads or crosslinking enhancers), stabilizers, dispersing agents, coupling agents, pigments, acid scavengers (for example, CaCO₃), other components, or combinations of these.

The adhesive 104 is manufactured by blending the lower-melt fluoropolymer with the fluoropolymer powder to form the adhesive 104. The adhesive 104 is applied to the surface 102 of the article 100 at the applying temperature. The adhesive 104 is configured to be exposed to the operational temperature. Upon exposing the surface 102 and/or the adhesive 104 to the operational temperature, in one embodiment, the adhesive generates little or no toxic and/or corrosive emissions.

In one embodiment, the adhesive 104 includes surface wet-ability corresponding to about or less than about 25 dynes/cm, about 20 dynes/cm, or any suitable combination, sub-combination, range, or sub-range therein.

In one embodiment, the adhesive 104 includes melt flow corresponding with viscosity, as indicated by log (complex viscosity), corresponding with embodiments shown in Table 1 of the Examples section below, and/or being between about 3 and about 5, between about 3 and about 4, between about 4 and about 5, at about 4, at about 4.5, at about 5, or any suitable combination, sub-combination, range, or sub-range therein.

In one embodiment, the adhesive 104 includes adhesion to aluminum, as indicated by shear strength (N/cm²), corresponding to embodiments shown in Table 1 of the Examples section below, and/or being between about 465 and about 853, between about 543 and about 853, between about 620 and about 853, between about 543 and about 775, at about 853, at about 775, at about 620, at about 543, or any suitable combination, sub-combination, range, or sub-range therein.

In one embodiment, the adhesive 104 includes adhesion to ETFE, as indicated by peel strength (N/cm), corresponding to embodiments shown in Table 1 of the Examples section below, and/or being between about 35 and about 63, between about 35 and about 59, between about 43 and about 55, between about 39 and about 47, between about 43 and about 47, between about 39 and about 55, at about 39, at about 43, at about 47, at about 55, or any suitable combination, sub-combination, range, or sub-range therein.

In one embodiment, the adhesive 104 further includes an additive (not shown), such as, a fluoroelastomer. A suitable fluoroelastomer has a specific gravity of about 1.76, a viscosity of about 500 poise (at 60° C.), a number average molecular weight of about 3,000, or a combination thereof (for example, as in DAI-EL G-101 available from Daikin America, Inc., of Orangeburg, N.Y.). In one embodiment, the additive does not substantially impact viscosity of the adhesive 104.

In one embodiment, the fluoroelastomer decreases adhesion of the adhesive 104 when the surface 102 is aluminum. In this embodiment, in comparison to the adhesive 104 having adhesion to the surface 102 of between about 512N/cm² and about 543 N/cm² or to about 527 N/cm², including the fluoroelastomer at a volume concentration of about 4% decreases the adhesion to between about 481 N/cm² and about 496 N/cm² or to about 488 N/cm², including the fluoroelastomer at a volume concentration of about 8% decreases the adhesion to between about 403 N/cm² and about 450 N/cm² or to about 434 N/cm², including the fluoroelastomer at a volume concentration of about 12% decreases the adhesion to between about 403 N/cm² and about 434 N/cm² or to about 419 N/cm², or any suitable combination, sub-combination, range, or sub-range therein.

In one embodiment, the fluoroelastomer increases or substantially does not affect adhesion of the adhesive 104 when the surface 102 is PTFE. In this embodiment, in comparison to the adhesive 104 having adhesion to the surface 102 of between about 39 N/cm and about 55 N/cm or to about 47 N/cm, including the fluoroelastomer at a volume concentration of about 4% results in adhesion of about 51 N/cm, including the fluoroelastomer at a volume concentration of about 8% results in adhesion of between about 39 N/cm and about 47 N/cm or about 43 N/cm, including the fluoroelastomer at a volume concentration of about 12% results in adhesion of between about 47 N/cm and about 55 N/cm or about 51 N/cm, or any suitable combination, sub-combination, range, or sub-range therein.

### EXAMPLES

Table 1 shows examples with the lower-melt component being THV (for example, Dyneon™ THV 2030 available from 3M, St. Paul, Minn., having a melting point of 130° C.) and the fluoropolymer powder being PTFE (for example, Polymist F5A, available from Solvay Solexis, Inc., Houston, Tex., and SST-2, available from Shamrock Technologies, Inc., Newark, N.J.). Example 1 is a comparative control. Examples 2 through 7 show embodiments of the disclosure.

TABLE 1

| | Lower-Melt | Fluoropolymer | Viscosity | Viscosity | Adhesion to | Shear on |
|---|---|---|---|---|---|---|
| Ex. | Component | Powder | (at 200° C.) | (at 260° C.) | Aluminum | ETFE |
| 1 | 100% | 0% | 3.8 | 3.2 | 1850 | 14 |
| (control) | | | | | (N/cm) | (N/cm²) |
| 2 | 90% | 10% | 4.2 | 3.6 | 1575 | 21 |
| | | (Polymist) | | | (N/cm) | (N/cm²) |
| 3 | 80% | 20% | 4.3 | 4.2 | 1378 | 19 |
| | | (Polymist) | | | (N/cm) | (N/cm²) |
| 4 | 70% | 30% | 5.1 | 5 | 1181 | 16 |
| | | (Polymist) | | | (N/cm) | (N/cm²) |
| 5 | 90% | 10% | n/a | n/a | 2165 | 16 |
| | | (SST-2) | | | (N/cm) | (N/cm²) |
| 6 | 80% | 20% | 4.4 | 3.8 | 1969 | 18 |
| | | (SST-2) | | | (N/cm) | (N/cm²) |
| 7 | 70% | 30% | n/a | n/a | 1575 | 22 |
| | | (SST-2) | | | (N/cm) | (N/cm²) |

Examples 8 through 13 of Table 2 show examples with the lower-melt component being THV (for example, Dyneon™ THV 2030 available from 3M, St. Paul, Minn., having a melting point of 130° C.) and the fluoropolymer powder being FEP (for example, FEP 20 having a lower molecular weight, FEP 15 having a higher molecular weight, and FEP 10 having the highest molecular weight, each having a melting point of 240° C.), according to embodiments of the disclosure, with the lower-melt component and the fluoropolymer powder being mixed at 160° C. and the fluoropolymer powder maintaining or substantially maintaining its form. Example 14, a comparative example, shows the lower-melt component being mixed at a temperature of 260° C., resulting in the fluoropolymer powder melting, to substantially form a higher-melt fluoropolymer.

TABLE 2

| | | Fluoropolymer | | | | |
|---|---|---|---|---|---|---|
| | Fluoropolymer | Powder | Lower-Melt | Lower-Melt | Adhesion to | Shear on |
| Ex. | Powder | Concentration | Component | Concentration | Fluoropolymer | Aluminum |
| 8 | FEP 10 | 20% | THV2030GZ | 80% | 54 | 732 |
| | (MP 240° C.) | (by volume) | (MP 130° C.) | (by volume) | (N/cm) | (N/cm²) |
| 9 | FEP 15 | 20% | THV2030GZ | 80% | 59 | 701 |
| | (MP 240° C.) | (by volume) | (MP 130° C.) | (by volume) | (N/cm) | (N/cm²) |
| 10 | FEP 20 | 20% | THV2030GZ | 80% | 61 | 690 |
| | (MP 240° C.) | (by volume) | (MP 130° C.) | (by volume) | (N/cm) | (N/cm²) |
| 11 | FEP 10 | 30% | THV2030GZ | 70% | n/a | 732 |
| | (MP 240° C.) | (by volume) | (MP 130° C.) | (by volume) | | (N/cm²) |
| 12 | FEP 15 | 30% | THV2030GZ | 70% | n/a | 402 |
| | (MP 240° C.) | (by volume) | (MP 130° C.) | (by volume) | | (N/cm²) |
| 13 | FEP 20 | 30% | THV2030GZ | 70% | n/a | 570 |
| | (MP 240° C.) | (by volume) | (MP 130° C.) | (by volume) | | (N/cm²) |
| 14 | FEP 15 | 20% | THV2030GZ | 80% | 55 | 612 |
| | (MP 240° C.) | (by volume) | (MP 130° C.) | (by volume) | (N/cm) | (N/cm²) |

As shown in Table 2, the differing results of Example 9 and Example 14 illustrate a surprising and unexpected result of increased adhesion to fluoropolymers and aluminum believed to be based upon the form of the fluoropolymer powder (although not intending to be bound by theory).

Table 3 shows examples 15 through 19 with the lower-melt component being THV (for example, Dyneon™ THV 2030 available from 3M, St. Paul, Minnesota, having a melting point of 130° C.) and a conductive powder instead of the fluoropolymer powder (for example, 5 micrometer dendritic copper).

TABLE 3

| | Conductive | Conductive | Lower-Melt | Lower-Melt | Adhesion to | Adhesion to |
|---|---|---|---|---|---|---|
| No. | Powder | Powder | Component | Concentration | Fluoropolymer | Aluminum |
| 15 | copper | 0% | THV2030GZ | 100% | 55 | 840 |
| | | (by volume) | (MP 130° C.) | (by volume) | (N/cm) | (N/cm²) |
| 16 | copper | 10% | THV2030GZ | 90% | 61 | 911 |
| | | (by volume) | (MP 130° C.) | (by volume) | (N/cm) | (N/cm²) |
| 17 | copper | 20% | THV2030GZ | 80% | 52 | 664 |
| | | (by volume) | (MP 130° C.) | (by volume) | (N/cm) | (N/cm²) |
| 18 | copper | 30% | THV2030GZ | 70% | 43 | 538 |
| | | (by volume) | (MP 130° C.) | (by volume) | (N/cm) | (N/cm²) |
| 19 | copper | 40% | THV2030GZ | 60% | 20 | 315 |
| | | (by volume) | (MP 130° C.) | (by volume) | (N/cm) | (N/cm²) |

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An adhesive manufacturing process, comprising:
blending a lower-melt fluoropolymer having a melting point that is less than a first temperature with a fluoropolymer powder having a melting point that is greater than a second temperature to form an adhesive; and
applying the adhesive to a surface at the first temperature;
wherein the adhesive is configured to be exposed to the second temperature; and wherein the second temperature is greater than about 200° C.

2. The adhesive manufacturing process of claim 1, wherein the size of particles in the fluoropolymer powder is between about 0.1 micrometers and about 100 micrometers.

3. The adhesive manufacturing process of claim 1, wherein the second temperature is about 300° C.

4. The adhesive manufacturing process of claim 1, further comprising exposing the surface to the second temperature.

5. The adhesive manufacturing process of claim 4, wherein the exposing to the second temperature generates no toxic emissions.

6. The adhesive manufacturing process of claim 4, wherein the exposing to the second temperature generates no corrosive emissions.

7. The adhesive manufacturing process of claim 1, wherein the surface is metal.

8. The adhesive manufacturing process of claim 1, wherein the surface is aluminum.

9. The adhesive manufacturing process of claim 1, wherein the surface is a fluoropolymer.

10. The adhesive manufacturing process of claim 1, wherein the surface is ethylene tetrafluoroethylene wire.

11. The adhesive manufacturing process of claim 1, wherein the surface is tape.

12. The adhesive manufacturing process of claim 1, wherein the lower-melt fluoropolymer component includes THV.

13. The adhesive manufacturing process of claim 1, wherein the lower-melt fluoropolymer component includes polyvinylidene fluoride.

14. The adhesive manufacturing process of claim 1, wherein the melting point of the lower-melt fluoropolymer component is between about 100° C. and about 260° C.

15. The adhesive manufacturing process of claim 1, wherein the fluoropolymer powder comprises polytetrafluoroethylene.

16. The adhesive manufacturing process of claim 1, wherein the lower-melt fluoropolymer includes fluorinated ethylene-propylene powder.

17. The adhesive manufacturing process of claim 1, wherein the surface is ethylene tetrafluoroethylene.

18. The adhesive manufacturing process of claim 1, further comprising exposing the surface to the second temperature, wherein:
the size of particles in the fluoropolymer powder is between about 0.1 micrometers and about 100 micrometers;
the exposing to the second temperature generates no toxic emissions and no corrosive emissions;
the surface is ethylene tetrafluoroethylene wire;
the lower-melt fluoropolymer component includes THV; and
the fluoropolymer powder comprises polytetrafluoroethylene.

19. An adhesive, comprising:
a lower-melt fluoropolymer having a melting point that is less than a first temperature; and
one or both of a conductive powder and a fluoropolymer powder blended with the lower-melt fluoropolymer, the fluoropolymer powder having a melting point that is greater than a second temperature;
wherein the adhesive is configured to be exposed to the second temperature.

20. An article, comprising:
a surface; and
an adhesive applied to the surface at an applying temperature, the adhesive comprising a lower-melt fluoropolymer having a melting point that is less than the applying temperature and a fluoropolymer powder blended with the lower-melt fluoropolymer, the fluoropolymer powder having a melting point that is greater than an operational temperature;
wherein the adhesive is configured to be exposed to the operational temperature.
